(19) United States
(12) Patent Application Publication
(10) Pub. No.: US 2009/0285179 A1
(43) Pub. Date: Nov. 19, 2009

(54) Long-Term Evolution (LTE) Packet Data Network Gateway (PDN-GW) Selection

(75) Inventors: D. Mark Jones, Ottawa (CA); Halim Ben-Hajla, Ottawa (CA)

Correspondence Address: STERNE, KESSLER, GOLDSTEIN & FOX P.L.L.C., 1100 NEW YORK AVENUE, N.W., WASHINGTON, DC, 20005, US

(73) Assignee: Bridgewater Systems Corp., Ottawa (CA)

(21) Appl. No.: 12/261,733

(22) Filed: Oct. 30, 2008

Related U.S. Application Data
(60) Provisional application No. 61/054,043, filed on May 16, 2008.

(51) Int. Cl. H04W 36/08

(52) U.S. Cl. 370/331

(57) ABSTRACT

The current 3rd Generation Partnership Project (3GPP) long-term evolution reference architecture defines a packet data network gateway (PDN-GW) selection function which is responsible for allocation of a packet data network gateway that provides packet data network connectivity for 3GPP and non-3GPP access for a given session. Systems and methods are provided for moving the PDN-GW selection function to a centralized network element (the HSS network element) for both 3GPP and non-3GPP access.

### CROSS REFERENCE TO RELATED APPLICATIONS

The present application claims the benefit of U.S. Provisional Patent Application No. 61/054,043, entitled “Long-Term Evolution (LTE) Packet Data Network Gateway (PDN-GW) Selection”, filed on May 16, 2008, which is hereby expressly incorporated by reference in its entirety.

### BACKGROUND OF THE INVENTION

1. Field of the Invention

The present invention relates generally to Third Generation Partnership Project (3GPP) networks and specifically to packet data network gateway selection in a 3GPP network.

2. Background Art

An increasingly large number of individuals use portable computing devices, such as laptop computers, personal data assistants (PDAs), smart phones and the like, to support mobile communications. The number of computing devices, and the number of networks that these devices connect to, has increased dramatically in recent years. Similarly, an increasing number of wireless Internet access services have been appearing in airports, cafes and book stores.

As telecommunications technology continues to evolve to meet this ever increasing demand, service providers continue to make investments in state-of-the-art technology in order to remain at the forefront of offerings in the marketplace. However, in order to maximize their return on investment, service providers are constantly challenged to more effectively market their technology offerings by offering richer choices to their subscriber base, and to deliver those choices in a timely and seamless fashion.

The Third Generation Partnership Project (3GPP) long term evolution (LTE) reference architecture defines a packet data network gateway (PDN-GW) selection function that is responsible for allocating a PDN-GW that provides PDN connectivity for 3GPP and non-3GPP access for a given user equipment (UE) IP-CAN session.

What is therefore needed is a technique for PDN gateway selection in a heterogeneous environment consisting of both 3GPP and non-3GPP access points. What is further needed is a technique for PDN gateway selection that accounts for loads on the PDN gateways. Through this network-based approach, connections can be distributed across PDN gateways in a more efficient manner, potentially reducing the number of PDN-GWs required in a network.

### BRIEF SUMMARY OF THE INVENTION

In an embodiment of the present invention, the PDN-GW selection is moved to the HSS for both 3GPP and non-3GPP access. In making this transition, no interface changes are required for either 3GPP access or non-3GPP access. As such, the MME/serving gateway or the gateway network element accesses the HSS to obtain the PDN-GW for the IP-CAN session.

In a further embodiment of the present invention, a centralized state store is included in the LTE network. The centralized state store includes load data information for each PDN-GW in the network. As such, the gateway selection function retrieves load data from the centralized state store for each PDN-GW in the list of allowed PDN-GWs for the UE requesting connectivity. Based on this load data, the gateway selection function makes the PDN-GW selection.

Further embodiments, features, and advantages of the invention, as well as the structure and operation of the various embodiments of the invention are described in detail below with reference to accompanying drawings.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 depicts a conventional operating environment providing PDN connectivity for 3GPP and non-3GPP access.

FIG. 2 depicts a block diagram of an operating environment for HSS-based PDN gateway selection, according to embodiments of the present invention.

FIG. 3 depicts a flowchart of an exemplary method for HSS-based PDN-GW selection, according to embodiments of the present invention.

FIG. 4 depicts a block diagram of an operating environment for centralized PDN-GW selection, according to embodiments of the present invention.

FIG. 5 is a diagram of a computer system on which the methods and systems herein described can be implemented, according to an embodiment of the invention.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE INVENTION

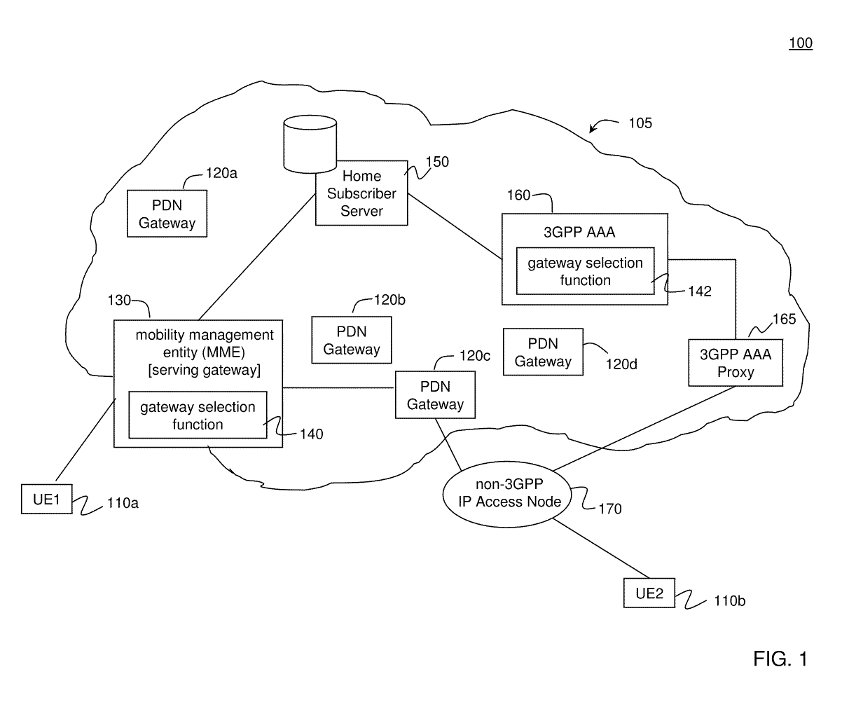

The Third Generation Partnership Project (3GPP) long term evolution (LTE) reference architecture defines a packet data network gateway (PDN-GW) selection function that is responsible for allocating a PDN-GW that provides PDN connectivity for 3GPP and non-3GPP access for a given user equipment (UE) IP-CAN session. FIG. 1 depicts a conventional operating environment 100 providing PDN connectivity for 3GPP and non-3GPP access. Operating environment 100 includes a 3GPP LTE network 105 and a non-3GPP network 170. 3GPP network 105 includes one or more mobility management entities (MMEs) 130, one or more packet data network (PDN) gateways 120a-d, a home subscriber server (HSS) 150, a 3GPP authentication, authorization, and accounting (AAA) server 160, and a 3GPP AAA proxy 165.

MME 130 includes a gateway selection function 140. The gateway selection function is configured to choose the appropriate PDN for a UE data session. The MME may further be collocated with a serving gateway. The MME/Serving gateway acts as a foreign agent for a mobile IP session. The PDN-GW provides an anchor for 3GPP and non-3GPP mobile IP sessions. That is, the PDN-GW acts as the home agent for the mobile IP session.

In the LTE architecture, two tunneling protocols are defined for enabling mobility, Proxy Mobile IP (PMIP) and GPRS Tunneling Protocol (GTP). Both protocols require a PDN-GW acting as an IP anchor point for mobility. The protocols from Serving Gateway to PDN-GW are referred to as “PMIP-based S8” and “GTP-based S8.” GTP is not supported in a non-3GPP access network. In embodiments, a PDN-GW 120 supports both GTP and PMIP on the same node.

HSS 150 stores a record for each subscriber to 3GPP network 105. The subscriber record includes a subscription profile, authentication vectors, and a list of allowed Access Point Names (APNs) for each subscriber. Each APN has a list of allowed PDN-GWs for the subscriber. An APN may be considered as the network name (e.g., Internet, corporate intranet, etc.). The HSS also has knowledge of the PDN-GW assignments for all active UE IP-CAN sessions. However, the HSS is a passive data store of this information (e.g., for the use of network elements involved in handover scenarios).

User equipment 1 (UE1) 110a attaches to LTE network 105 over the 3GPP Radio Access Network (RAN). The UE provides an APN in the attach request. Upon receiving the connection attempt, UE 110a is then authenticated/authorized by MME 130. MME 130 also invokes gateway selection function 140 to select a PDN gateway for the IP-CAN session with UE1 110a. Gateway selection function 140 accesses HSS 150 to retrieve a list of PDN-GWs serving the identified APN. The HSS may also return the subscriber profile and authentication vectors for UE1. The gateway selection function 140 selects a PDN-GW to anchor the mobile IP session from the received list according to a local selection algorithm.

User equipment 2 (UE2) 110b attempts to access 3GPP LTE network 105 via a non-3GPP network/access point. For example, this access may be via a Wi-Fi network or a non-GSM wireless network such as CDMA. For non-3GPP access, the gateway selection function resides either in the 3GPP AAA server 160 (as shown in FIG. 1) or the 3GPP AAA proxy 165. The method for access depends upon whether the non-3GPP network/access point is trusted or untrusted.

In the non-3GPP access scenario, an equivalent to the serving gateway originates an authentication request. The authentication request is sent to the 3GPP AAA proxy sitting on the border of the network. The 3GPP AAA proxy accesses the HSS via the 3GPP AAA server to retrieve the authentication vectors, subscriber profiles, and a list of allowed PDN-GWs. The gateway selection function may reside in the 3GPP AAA proxy, the 3GPP AAA server, or possibly in the non-3GPP network. The gateway selection function returns the PDN-GW selection to the non-3GPP access point which then establishes the connection with the selected PDN-GW.

Because the gateway selection function is distributed among the MMEs for 3GPP access and the 3GPP AAA server/proxy for non-3GPP access, a single MME does not have a complete view of the load on any PDN-GW. For example, MME 130, at most, may have information on the PDN gateway connections initiated by MME 130 but will not have information on the connections on the same PDN-GWs initiated by other MMEs or the 3GPP AAA server/proxy. This distribution makes it difficult to design an efficient load balancing function that ensures that the PDN-GWs are evenly loaded.

What is therefore needed is a technique for PDN gateway selection that accounts for loads on the PDN gateways. Through this network-based approach, connections can be distributed across PDN gateways in a more efficient manner, potentially reducing the number of PDN-GWs required in a network.

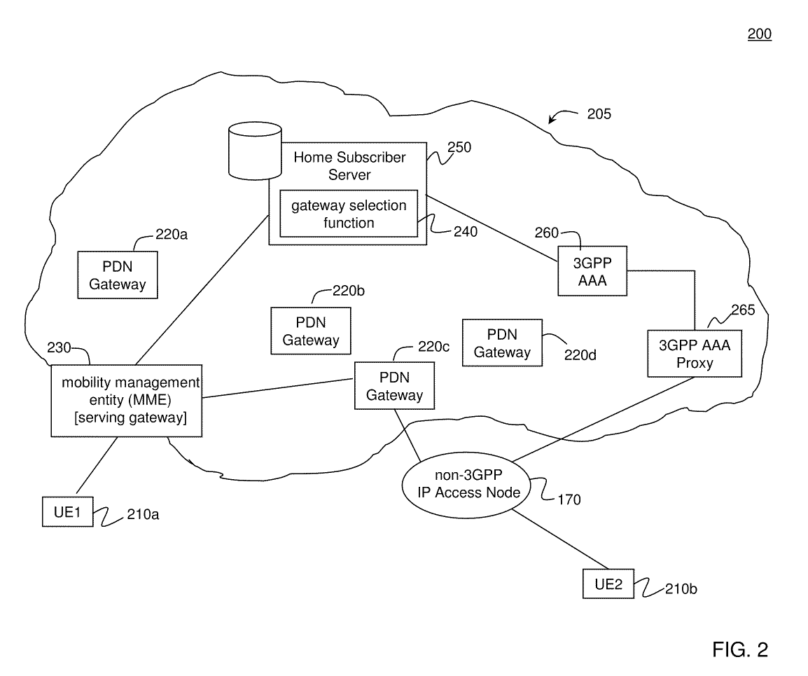

FIG. 2 depicts a block diagram of an operating environment 200 for HSS-based PDN gateway selection, according to embodiments of the present invention. In this embodiment, the PDN-GW selection function is moved to the HSS for both 3GPP and non-3GPP access. No interface changes are required for either 3GPP access or non-3GPP access.

Operating environment 200 includes a 3GPP LTE network 205. 3GPP network 205 includes one or more MMEs 230, HSS 250, one or more PDN-GWs 220a-d, a 3GPP AAA 260, and a 3GPP proxy 265. HSS 250 includes the gateway selection function 240. HSS 250 further includes a set of subscriber records. Each subscriber record includes a list of APNs for the subscriber as well as authentication vectors for the subscriber. As described above, each APN includes a list of allowed PDN-GWs for the subscriber. HSS also includes network topology data (for LTE network and/or non-3GPP access networks) and traffic data. For example, the HSS may include details related to the current load on the PDN GWs in the network. In an embodiment, HSS 250 is configured to resolve an APN to a list of PDN-GWs as a pre-condition to the gateway selection function. Gateway selection function 240 is configured to select a PDN gateway for a subscriber session based on the subscriber data, the network traffic data, and optionally network or network element topology data.

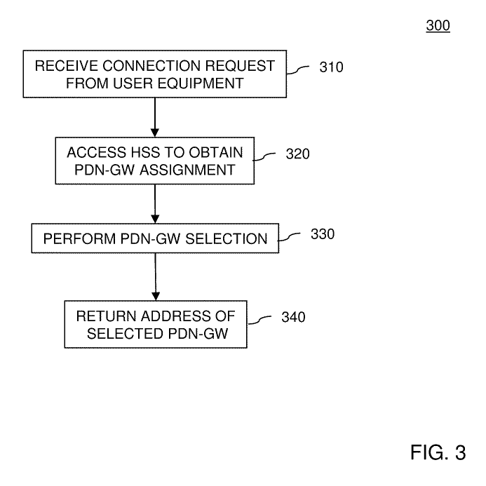

FIG. 3 depicts a flowchart 300 of an exemplary method for HSS-based PDN-GW selection, according to embodiments of the present invention. FIG. 3 is described with continued reference to the operating environment of FIG. 2. However, flowchart 300 is not limited to that embodiment.

In step 310, a connection request is received from a UE. As described above, the request includes an APN. For 3GPP access, an MME/serving gateway receives the access request. For non-3GPP access, a gateway network element receives the access request.

In step 320, the MME/serving gateway or the gateway network element accesses the HSS 250 to obtain the PDN-GW for the IP-CAN session.

In step 330, the HSS performs the PDN-gateway selection. In an embodiment, as a pre-condition to gateway selection, the HSS resolves the received APN to a list of allowed PDN-GWs for the subscriber. In this step, the list of allowed PDN-GWs for the UE is retrieved from the HSS data store and provided to the gateway selection function in the HSS. The gateway selection function resolves the list to a single PDN-GW based on the current load of the listed PDN-GWs. In addition, the gateway selection function may consider the Serving Gateway topology (for 3GPP access) or the access network topology (for non-3GPP access) when making the PDN-GW selection.

In step 340, the address of the selected PDN-GW is returned to the MME/Serving Gateway (for 3GPP access) or the gateway network element (for non-3GPP access).

The 3GPP standards currently describe a scenario by which the HSS returns a single PDN-GW address. However, this scenario is limited to situations where there is a static subscriber-to-PDN gateway relationship created at provisioning time. This static provisioning does not allow for load balancing across PDN-GWs in a network.

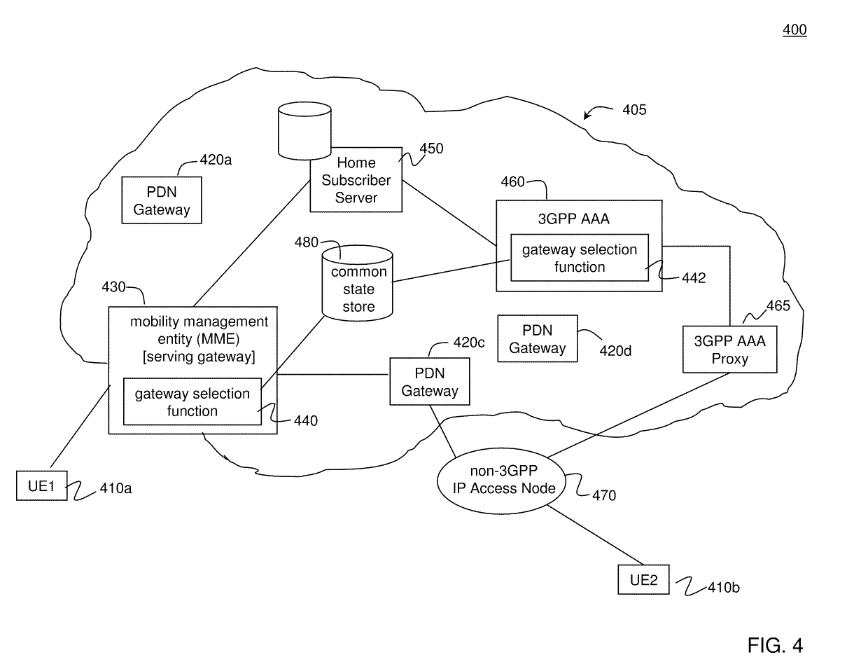

FIG. 4 depicts a block diagram of an operating environment 400 for centralized PDN-GW selection, according to embodiments of the present invention. In this embodiment, a centralized state store 480 is included in LTE network 405. The centralized state store 480 includes load data information for each PDN-GW in the network. In this embodiment, the gateway selection function (e.g., in the MME or 3GPP server/proxy) retrieves load data from the central state store 480 for each PDN-GW in the list of allowed PDN-GWs for the UE requesting connectivity. The gateway selection function then uses load data when making the PDN-GW selection.

### Computer System Implementation

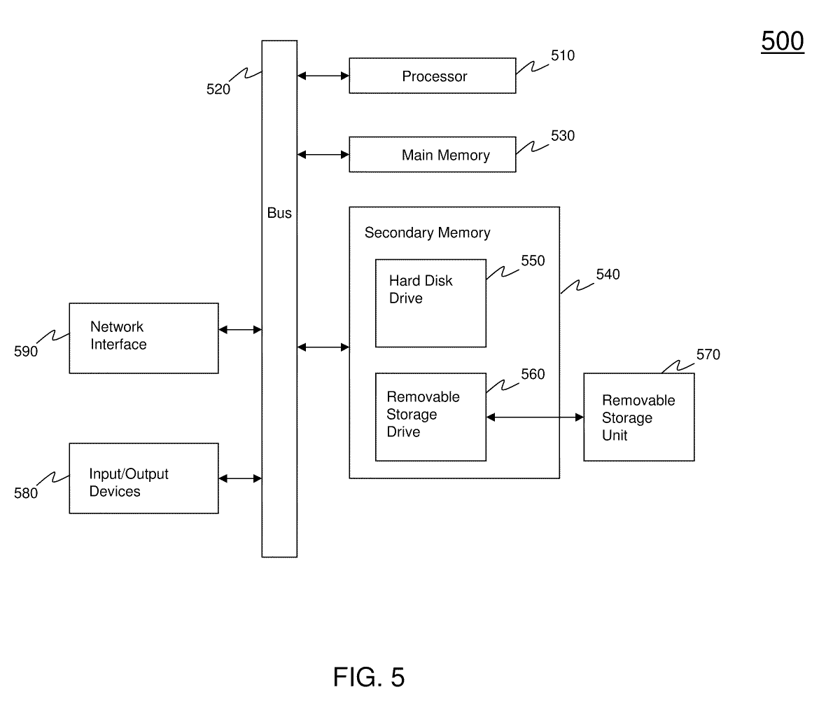

In an embodiment of the present invention, the methods and systems of the present invention described herein are implemented using well known computers, such as a computer 500 shown in FIG. 5. The computer 500 can be any commercially available and well known computer capable of performing the functions described herein, such as computers available from International Business Machines, Apple, Sun, HP, Dell, Cray, etc.

Computer 500 includes one or more processors (also called central processing units, or CPUs), such as processor 510. Processor 510 is connected to communication bus 520. Computer 500 also includes a main or primary memory 530, preferably random access memory (RAM). Primary memory 530 has stored therein control logic (computer software), and data.

Computer 500 may also include one or more secondary storage devices 540. Secondary storage devices 540 include, for example, hard disk drive 550 and/or removable storage device or drive 560. Removable storage drive 560 represents a floppy disk drive, a magnetic tape drive, a compact disk drive, an optical storage device, tape backup, ZIP drive, JAZZ drive, etc.

Removable storage drive 560 interacts with removable storage unit 570. As will be appreciated, removable storage unit 560 includes a computer usable or readable storage medium having stored therein computer software (control logic) and/or data. Removable storage drive 560 reads from and/or writes to the removable storage unit 570 in a well known manner.

Removable storage unit 570, also called a program storage device or a computer program product, represents a floppy disk, magnetic tape, compact disk, optical storage disk, ZIP disk, JAZZ disk/tape, or any other computer data storage device. Program storage devices or computer program products also include any device in which computer programs can be stored, such as hard drives, ROM or memory cards, etc.

In an embodiment, the present invention is directed to computer program products or program storage devices having software that enables computer 500, or multiple computer 400s to perform any combination of the functions described herein

Computer programs (also called computer control logic) are stored in main memory 530 and/or the secondary storage devices 540. Such computer programs, when executed, direct computer 500 to perform the functions of the present invention as discussed herein. In particular, the computer programs, when executed, enable processor 510 to perform the functions of the present invention. Accordingly, such computer programs represent controllers of the computer 500.

Computer 500 also includes input/output/display devices 580, such as monitors, keyboards, pointing devices, etc.

Computer 500 further includes a communication or network interface 590. Network interface 590 enables computer 500 to communicate with remote devices. For example, network interface 590 allows computer 500 to communicate over communication networks, such as LANs, WANs, the Internet, etc. Network interface 590 may interface with remote sites or networks via wired or wireless connections. Computer 500 receives data and/or computer programs via network interface 590. The electrical/magnetic signals having contained therein data and/or computer programs received or transmitted by the computer 500 via interface 590 also represent computer program product(s).

The invention can work with software, hardware, and operating system implementations other than those described herein. Any software, hardware, and operating system implementations suitable for performing the functions described herein can be used.

As noted earlier, benefits of various embodiments of the current invention find applicability to the current 3GPP Release 7, to the upcoming Release 8, as well as to future releases of the 3GPP specifications.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

### Conclusion

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

The breadth and scope of the present invention should not be limited by any of the above-described exemplary embodiments, but should be defined only in accordance with the following claims and their equivalents.

What is claimed is:

1. A system, comprising:
a gateway entity adapted to receive a connection request from a user-equipment (UE), wherein the connection request includes an Access Point Name (APN); and
a gateway selection function (GSF) module coupled, at least indirectly, to the gateway entity, wherein the GSF module is adapted to select a packet data network gateway (PDN-GW) based on the connection request and to return the selected PDN-GW to the gateway entity.

2. The system of claim 1, wherein the GSF module is located in a home subscriber server (HSS).

3. The system of claim 1, wherein the GSF module is located in a MME and the GSF module accesses a centralized server store to obtain load data.

4. The system of claim 1, wherein the GSF module selects the packet data network gateway (PDN-GW) based, in part, on a load balancing algorithm.

5. The system of claim 1, wherein the GSF module selects the packet data network gateway (PDN-GW) based, in part, on network topology.

6. The system of claim 1, wherein the gateway entity is a gateway network element.

7. The system of claim 1, wherein the gateway entity is a MME/serving gateway.

8. A method, comprising:
receiving by a gateway entity a connection request from a user-equipment (UE), wherein the connection request includes an Access Point Name (APN);
accessing a gateway selection function (GSF) module to obtain the packet data network gateway (PDN-GW) for the IP-CAN session;
selecting the PDN-GW by the GSF module based on the connection request; and
returning the selected PDN-GW to the gateway entity.

9. The method of claim 8, further comprising:
prior to the selecting, resolving the received APN to a list of allowed PDN-GWs.

10. The method of claim 8, wherein the GSF module is located in a home subscriber server (HSS).

11. The method of claim 8, wherein the GSF module selects the packet data network gateway (PDN-GW) based, in part, on a load balancing algorithm.

12. The method of claim 8, wherein the GSF module selects the packet data network gateway (PDN-GW) based, in part, on network topology.

13. The method of claim 8, wherein the gateway entity is a gateway network element.

14. The method of claim 8, wherein the gateway entity is a MME/serving gateway.

15. A computer-readable medium containing instructions for controlling at least one processor by a method, comprising:
receiving by a gateway entity a connection request from a user-equipment (UE), wherein the connection request includes an Access Point Name (APN);
accessing a gateway selection function (GSF) module to obtain the packet data network gateway (PDN-GW) for the IP-CAN session;
selecting the PDN-GW by the GSF module based on the connection request; and
returning the selected PDN-GW to the gateway entity.

16. The computer-readable medium of claim 15, further comprising:
prior to the selecting, resolving the received APN to a list of allowed PDN-GWs.

17. The computer-readable medium of claim 15, wherein the GSF module is located in a home subscriber server (HSS).

18. The computer-readable medium of claim 15, wherein the GSF module selects the packet data network gateway (PDN-GW) based, in part, on a load balancing algorithm.

19. The computer-readable medium of claim 15, wherein the GSF module selects the packet data network gateway (PDN-GW) based, in part, on network topology.

20. The computer-readable medium of claim 15, wherein the gateway entity is a gateway network element.

21. The computer-readable medium of claim 15, wherein the gateway entity is a MME/serving gateway.
